(19) United States
(12) Patent Application Publication
(10) Pub. No.: US 2026/0307422 A1
(43) Pub. Date: Oct. 8, 2026

(54) OPTICAL SECURITY COMPONENTS, MANUFACTURE OF SUCH COMPONENTS AND SECURE OBJECTS PROVIDED WITH SUCH COMPONENTS

(71) Applicant: SURYS, Bussy Saint Georges (FR)

(72) Inventors: Nelson Gananathan, Bussy Saint Georges (FR); Valéry Petition, Meaux (FR)

(73) Assignee: SURYS, Bussy Saint Georges (FR)

(21) Appl. No.: 19/478,672

(22) PCT Filed: Mar. 29, 2024
(86) PCT No.: PCT/EP2024/058748

§ 371 Date: Oct. 24, 2025

(30) Foreign Application Priority Data
Apr. 27, 2023 (FR) 2304276

(51) Int. Cl. B42D 25/324; B42D 25/328; B42D 25/351; B42D 25/373

(52) U.S. Cl. CPC B42D 25/324; B42D 25/328; B42D 25/351; B42D 25/373

(57) ABSTRACT

An optical security component may include a first layer, a first diffractive structure etched into the first layer, a second reflective layer partially covering the first diffractive structure. The first diffractive structure may include a set of optical elements adjacent to each other. Each optical element may have a maximum dimension of less than about 300 μm and include a microstructure modulated by a sub-wavelength diffraction grating. Each microstructure may deflect an incident light beam and be substantially invariant by azimuthal rotation by an angle of less than 90° about a first axis. The diffraction grating may be substantially invariant by azimuthal rotation by an angle of less than 90° about a second axis substantially coincident with the first axis and produce a colored effect after the second layer has been deposited.

### TECHNICAL FIELD OF THE INVENTION

The present description relates to the field of security marking. More specifically, it relates to optical security components for verifying the authenticity of an object, for example a valuable product or document, for example an identity document or a banknote, to a method for manufacturing such a component and to a secure object equipped with such a document. Notably, the present description relates to optical security components for verifying the authenticity of an object with the naked eye or by means of an optical imaging device.

### PRIOR ART

Numerous technologies are known for authenticating documents or products, and notably for securing documents such as valuable documents, documents such as banknotes, passports or other identification documents. These technologies are aimed at producing optical security components, the optical effects of which, as a function of the observation parameters (orientation of the component relative to the observation axis, position and dimensions of the light source, etc.) have highly characteristic and verifiable configurations. The general aim of these optical components is to provide new and differentiated optical effects, based on physical configurations that are difficult to reproduce. These components include DOVID “Diffractive Optical Variable Image Device” components, which are optical components producing diffractive and variable images commonly called holograms.

The present description relates to optical security components exhibiting noteworthy colored optical effects in reflection, as well as to optical security components exhibiting noteworthy colored optical effects both in reflection and in transmission.

Checking in transmission is notably used in valuable documents, for example, banknotes that to this end have a recessed and/or partially transparent zone or passports that include a page of data relating to the carrier that is provided with a transparent window. The optical security component can be, for example, in the form of a security thread, a security strip, or a patch, intended to be seen from above, at least partially superimposed on the transparent zone, and being able to be positioned on the surface or in the thickness of the document.

Optical security components that are observable in reflection and in transmission are known, for example, which implement resonance mechanisms in a layer of dielectric material. Such optical security components are described, for example, in patent application EP 2264491 [Reference 1] or in the article by M. T. Gale et al., [Reference 2] and are known as zero-order diffractive filters (ZOF) or guided-mode resonant filters. The physical mechanism is based on a resonant reflection of a guided mode in the dielectric layer, for example, a high-index layer. Noteworthy colored effects are visible in reflection and in transmission. In particular, when they are illuminated, for example, with non-polarized polychromatic light, the zero-order diffractive filters (ZOF) can exhibit characteristic and differentiated color effects when they undergo azimuthal rotation and are therefore clearly identifiable.

Optical security components with plasmon resonance are also known that have noteworthy colored optical effects, in reflection or in transmission.

Published patent application WO 2013/060817 [Reference 3] describes, for example, an optical security component intended to be observed in the visible spectrum in direct reflection. The optical security component described in [Reference 3] comprises a continuous metal layer forming, with a layer of dielectric material, a metal-dielectric interface, with the thickness of the metal layer being sufficient to allow incident light to reflect on the interface. The metal layer is structured in the vicinity of the interface in order to form, in a first coupling zone, two sets of corrugations that extend in two directions and form a two-dimensional coupling grating, with sub-wavelength periods in each direction. In such an optical security component, original and contrasted color variation effects are observed, notably by azimuthal rotation of the component. These noteworthy effects can be explained by plasmon resonance effects at the metal-dielectric interface, which allows a reflection band-stop filter to be produced that varies as a function of the observation conditions. Published patent application WO 2020/229415 [Reference 4] also describes an optical security component intended to be observed in the visible spectrum in direct reflection. In this example, a first layer of dielectric material, a second layer of dielectric material and a metal layer form a dual dielectric-dielectric-metal interface, comprising a dielectric-dielectric interface and a dielectric-metal interface, and structured to form a two-dimensional coupling grating with sub-wavelength periods. This results in plasmon resonance in a first spectral resonance band and hybrid plasmon resonance, in a second spectral resonance band different from said first spectral band.

The optical security components described in the aforementioned references, implementing guided-mode resonance effects or plasmon resonance effects, are zero-order color filters, i.e., they observe in direct reflection.

It should be noted that optical security components with plasmon resonance are also known that act as color filters and exhibit noteworthy colored optical effects in transmission. Such components are described, for example, in patent application US 2010/0307705 [Reference 5] or in published patent application WO 2012/136777 [Reference 6].

It is known for more complex visual effects to be generated from the color filters thus described, notably dynamic visual effects, in order to generate an additional authentication check.

Thus, by way of an example, published patent application WO 2015/154943 [Reference 7] describes an optical security component comprising a diffractive structure etched into a layer of dielectric material. The structure has a first pattern comprising a low-relief with a first set of facets whose shapes are determined in order to simulate a series of concave or convex cylindrical optical elements that are visible in reflection. The first pattern is modulated by a second pattern forming a sub-wavelength grating and configured to generate, after depositing a layer of dielectric material and encapsulating the structure, a guided-mode resonant filter (ZOF). Such an optical security component exhibits a dynamic visual effect of light strips with different colors and moving in opposite directions when it undergoes a tilted rotation about an axis parallel to one of the main directions of the cylindrical elements. Furthermore, color changes can be observed during an azimuthal rotation of the component.

Thus, the resonance mechanisms in the optical security components, some of which are described by way of examples in the aforementioned references, are known for the noteworthy optical effects that they produce. In addition to the fact that such optical security components comprise structures that are difficult to reproduce, they are consequently excellent candidates in the field of security marking.

The present application describes an optical security component that also implements such resonance mechanisms and whose original structure allows original visual effects to be obtained compared to those known from the prior art, allowing even more secure authentication.

### SUMMARY OF THE INVENTION

In the present description, the term “comprise” means the same as “include”, “contain”, and is inclusive or open and does not exclude other elements that are not described or shown.

Furthermore, in the present description, the term “about” or “substantially” means the same as “having a margin that is less than and/or greater than 10%, for example, 5%”, of the respective value.

According to a first aspect, the invention relates to an optical security component for securing an object, for example a valuable document, for example an identity document or a banknote.

The optical security component according to the first aspect comprises:

a first layer of dielectric material, transparent in the visible spectrum, having a first refractive index;
at least a first diffractive structure etched into said first layer; and
a second layer, at least partially covering said first diffractive structure, and having a reflection spectral band in the visible spectrum; and wherein:
said first diffractive structure consists of a set of optical elements adjacent to each other, each optical element having a maximum dimension of less than about 300 μm and comprising a microstructure modulated by a sub-wavelength diffraction grating with one or more pitches ranging between about 150 nm and about 500 nm, such that:
   said microstructure is configured to deflect an incident light beam and is substantially invariant by azimuthal rotation by an angle of less than 90° about a first axis substantially perpendicular to a plane of the component;
   said sub-wavelength diffraction grating is substantially invariant by azimuthal rotation by an angle of less than 90° about a second axis substantially coincident with said first axis and is configured to produce a colored effect after the second layer has been deposited.

In the present description, a transparent layer in the visible spectrum is defined as a layer with transmission of at least 70%, preferably at least 80% for a wavelength included in the visible spectrum, i.e., a wavelength ranging between about 400 nm and about 800 nm. A layer accordingly transparent allows the layers located under the transparent layer to be observed with the naked eye.

In the present description, said microstructure is substantially invariant by azimuthal rotation by a given angle of less than 90° about a first axis substantially perpendicular to a plane of the component; this means that a rotation of said microstructure about said first axis with said angle generates a microstructure that substantially superimposes on the microstructure before azimuthal rotation. According to one or more embodiments, said angle is less than about 60°, advantageously less than about 45°. In some embodiments, said microstructure is substantially rotationally symmetrical about said first axis, which forms an axis of symmetry. In a known manner, in the case whereby an object or a physical system is invariant by any arbitrary rotation of any angle about an axis, reference is made to continuous symmetry. In this case, it is simply understood that the system allows an axis of symmetry, without any other specification. Objects or systems also exist in which there is only symmetry about the axis for certain values of the angle of rotation. This type of rotational symmetry is said to be discrete, as opposed to the preceding case. More specifically, an axis of symmetry of order n is such that the system is invariant by any rotation by an angle 2π/n, with n being a positive integer. Of course, when an object or physical structure is invariant by a rotation by an angle 2π/n, it is invariant by rotation by any angle that is a multiple of 2π/n. Thus, in the present description, the microstructure generally can be described as a symmetrical microstructure of order n about said first axis, with n being greater than or equal to 4. When n is very large, the microstructure resembles a microstructure with rotational symmetry.

In the present description, said diffraction grating is substantially invariant by azimuthal rotation by an angle of less than 90° about a second axis substantially coincident with said first axis; this means that an azimuthal rotation of a projection in the plane of the component of said diffraction grating about said second axis, with said angle, generates a diffraction grating that substantially superimposes the diffraction grating before azimuthal rotation.

According to one or more embodiments, said angle is less than about 60°, advantageously less than about 45°. In some embodiments, said diffraction grating is substantially rotationally symmetrical about said second axis.

Thus, as explained above, the diffraction grating can be invariant by any arbitrary rotation of any angle about said second axis and the grating has rotational symmetry about said second axis. In the present description, the diffraction grating can be generally described as a symmetrical diffraction grating of order n about said second axis, with n being greater than or equal to 4, i.e., an azimuthal rotation of a projection in the plane of the component of said diffraction grating around said second axis, with an angle equal to 2π/n or any multiple of this angle, generates a diffraction grating that substantially superimposes the diffraction grating before azimuthal rotation.

The optical component according to the first aspect is particularly noteworthy in that it allows a texture to be generated (the optical elements are each invisible to the naked eye) that has an original colored optical effect, namely, a colored effect, for example a variable colored effect with one or more tilting movements, with this colored effect being preserved under the effect of an azimuthal rotation.

For authentication with the naked eye, it is thus possible to observe a first color that is stable or variable during a right/left and/or up/down movement (or tilt) and/or a second color that is stable or variable during a right/left and/or up/down movement (or tilt), but whatever the colored effect observed during a right/left and/or up/down movement (or tilt), this same colored effect will be observed after azimuthal rotation. This preservation of the colored effect by azimuthal rotation further facilitates any checking. In practice, the preservation of the colored effect will be obtained for at least one angle of azimuthal rotation ranging between about 30° and about 150°, advantageously between about 60° and about 120°.

In the present description, an azimuthal rotation of the optical security component is referred to as the rotational movement of the component about an axis substantially perpendicular to a plane of the component.

The term “tilt” refers to a rotational movement of the component about an axis lying in a plane of the component. From the perspective of a user, it is possible to define a plane of incidence of the light that includes a lighting axis of the component and an observation axis. A right/left tilt is a rotational movement about an axis lying in the plane of the component and in the plane of incidence and an up/down tilt is a rotational movement about an axis lying in the plane of the component and perpendicular to the plane of incidence.

This technical effect results from the original structure of the optical security component in which a sub-wavelength grating, which is rotationally invariant, is centered on each of the microstructures, which is also rotationally invariant and is modulated by said grating.

Unlike the optical security components of the prior art implementing resonant effects that produce colored effects that can only be observed in direct reflection, it is also possible to obtain, in some embodiments of optical security components according to the first aspect, tilted color stability over wide angular ranges.

Moreover, since the optical security component forms a texture with microstructures that are invisible to the naked eye, it is possible to generate any macroscopic pattern that is visible to the naked eye and is easily recognizable simply by providing a contour corresponding to the first diffractive structure.

Thus, according to one or more embodiments, said first diffractive structure has a contour configured to generate a macroscopic pattern recognizable to the naked eye by an observer. Said macroscopic pattern has a minimum dimension that is greater than 500 μm, preferably greater than 1 mm, preferably greater than 2 mm, preferably greater than 5 mm. Such a minimum dimension allows a pattern to be generated that is recognizable to the naked eye. The optical component according to the first aspect also has numerous advantages for machine authentication, i.e., by means of a fixed or portable optical imaging device, compared to the components of the prior art. On the one hand, the preservation of a variable colored effect by azimuthal rotation by tilting will simply be able to be observed. On the other hand, the preservation of the variable colored effect by azimuthal rotation allows any positioning inaccuracy when checking the authentication of the colored effect to be limited. The conditions for the authentication check are thus facilitated.

In an optical security component according to the present description, said first diffractive structure consists of a set of optical elements adjacent to one another, with each optical element comprising a microstructure modulated by a diffraction grating. According to one or more embodiments, a number of optical elements of said first diffractive structure ranges between about 300 and about 40 000. This number is suitable, for example, for optical elements with a maximum dimension ranging between about 50 μm and about 200 μm, for example between about 70 μm and about 150 μm, in order to form a diffractive structure, the surface of which ranges between about 200 mm² and about 800mm², which corresponds, for example, to surfaces of security threads, strips or patches.

According to one or more embodiments, each optical element has a contour with a given shape selected from among: a circular shape, a rectangular shape, for example a square shape, a hexagonal shape. Such shapes can allow an arrangement of the optical elements to be provided that optimizes the number of optical elements on a given surface.

According to one or more embodiments, the optical elements are arranged in an even arrangement with a hexagonal mesh, which allows the number of optical elements on a given surface to be maximized. Other meshes are possible, for example a rectangular mesh or a square mesh.

According to one or more embodiments, the optical elements of said first diffractive structure are identical. In other embodiments, they can be different. For example, they can comprise microstructures modulated by different diffraction gratings. In some embodiments, they can comprise different microstructures.

According to one or more embodiments, the microstructures comprise microlenses, for example spherical or aspherical microlenses.

According to one or more embodiments, the microstructures comprise subsets of facets each comprising a plurality of facets.

In some embodiments, the facets are substantially rotationally symmetrical and are arranged concentrically or pseudo-concentrically (for example in the form of a spiral) about said first axis. In other embodiments, the facets are comparable to straight segments, the quantity and dimensions of which are linked to the angle of invariance of the microstructure by azimuthal rotation; for example, as a top view, the facets could have a regular polygonal shape, for example a hexagonal or octagonal shape.

The plurality of facets is configured to form a microstructure for deflecting an incident beam. Each facet has a given height and width.

In the present description, the “height” of a facet refers to a distance between a lowest level of the facet and a highest level, with the distance being measured along an axis perpendicular to a plane parallel to the plane of the component.

The “width” of a facet refers to a width of the crown resulting from the projection of the facet in a plane parallel to the plane of the component.

A width of the facets is advantageously greater than or equal to about 4 times, advantageously greater than or equal to about 8 times, a pitch of the diffraction grating. The minimum dimension therefore can be selected as a function of the period of the grating. For example, a minimum dimension of the width of the facets is equal to about 2 μm.

According to one or more examples, the width of the facets ranges between about 2 μm and about 100 μm, advantageously between about 2 μm and about 80 μm, advantageously about 4 um and about 40 μm.

According to one or more embodiments, the set of facets have a substantially identical height. The height of the facets is, for example, less than about 2 microns, advantageously less than about 1 micron. According to one or more examples, the facets from among the set of facets have different heights. In this case, however, the facets have a maximum height. Said maximum height is, for example, less than about 2 microns, advantageously less than about 1 micron.

According to one or more embodiments, the set of facets have a low level located in the same plane. In other embodiments, the low levels of the facets are not in the same plane. In the case of facets assuming different heights, midpoints of the facets located between the low level and the high level can lie, for example in the same plane.

According to one or more embodiments, said minimum angular value of the slope of a facet (as an absolute value) is equal to about 1°. According to one or more embodiments, said maximum angular value of the slope of a facet (as an absolute value) is equal to about 45° According to one or more examples, the angular value of the slope of a facet (as an absolute value) ranges between about 1° and about 30°, advantageously between about 2° and about 15°.

According to one or more embodiments, each subset of facets comprises a plurality of facets, for example between 2 facets and about 150 facets, advantageously between 2 facets and about 50 facets, advantageously between 3 and about 50 facets, for example between 3 and 10 facets.

According to one or more embodiments, each subset of facets comprises a plurality of facets arranged concentrically and the arrangement of the facets in at least one portion of the subset of facets is such that the facets are arranged with variable slopes and the variation of which increases as an absolute value from the center of the subset of facets toward the edge of the subset of facets, and the variation of which alternately decreases as an absolute value from the center of the subset of facets toward the edge of the subset of facets, with the subset of facets forming a structure of the “Fresnel lens” type. Each Fresnel lens has a diameter of less than 300 μm, such that it is not visible to the naked eye.

According to one or more embodiments, each subset of facets comprises a plurality of facets arranged with alternately positive and negative variables slopes, and the variation of which increases as an absolute value from the center of the subset of facets toward the edge of the subset of facets, and the variation of which alternately decreases as an absolute value from the center of the subset of facets toward the edge of the subset of facets, with the subset of facets forming a structure that is referred to as an “axicon” in the present description. Each axicon has a diameter of less than 300 μm, such that it is not visible to the naked eye.

Of course, other arrangements are possible for the facets of the subsets of facets configured to produce microstructures that allow light to be deflected. One advantage of such microstructures compared to microlens type microstructures, for example, is the limited height of such a microstructure, typically a height of less than about 2 μm.

In an optical security component according to the first aspect, the diffraction grating that modulates each microstructure is a sub-wavelength diffraction grating. In practice, said diffraction grating comprises one or more pitches ranging between about 150 nm and about 400 nm, advantageously ranging between about 200 nm and about 400 nm.

In an optical security component according to the first aspect, a projection, in the plane of the component, of the diffraction grating that modulates each microstructure is substantially invariant by azimuthal rotation by a given angle about a second axis substantially coincident with the first axis of said microstructure. Such a diffraction grating can be a concentric or pseudo-concentric grating (for example in the form of a spiral), a radial or pseudo-radial grating, a two-dimensional grating with a concentric or pseudo-concentric dimension and a radial or pseudo-radial dimension.

In the present description, a concentric diffraction grating refers to a diffraction grating comprising concentric grating lines centered on said second axis. Such a diffraction grating can have a constant pitch, a plurality of pitches or a variable pitch.

In the present description, a pseudo-concentric diffraction grating refers to a spiral-shaped diffraction grating; for example a pseudo-concentric diffraction grating comprises a line with a substantially increasing radius so as to describe a spiral whose origin is the center of the grating defined by the intersection of the plane of the component with said second axis, and which is centered on said center of the grating. Such a diffraction grating can have a constant pitch (for example a spiral of the Archimedes spiral type), a plurality of pitches or a variable pitch (for example a spiral of the Fermat spiral type).

A radial diffraction grating refers to a diffraction grating comprising radial grating lines that extend from the center of the grating defined by the intersection of the plane of the component with said second axis. In a radial diffraction grating, the pitch is, for example, an average pitch, defined, for example, at a distance from the center equal to half a radius.

A pseudo-radial diffraction grating refers to a diffraction grating comprising radial grating lines that extend from the center of the grating defined by the intersection of the plane of the component with said second axis and pseudo-radial grating lines, parallel to the grating lines extending radially from the center of the grating. A pseudo-radial grating allows angular sectors to be defined, inside which the grating lines are parallel, which allows a substantially constant pitch to be provided.

The angular sectors have a vertex angle ranging, for example between about 2° and about 60°, for example between about 10° and about 60°.

More generally, in some embodiments, the diffraction grating can comprise angular sectors, inside which the grating lines are parallel, which allows a substantially constant pitch to be provided within each angular sector. The term “angularly sectorized” diffraction grating is used in the present description. The angular sectors have a vertex angle ranging, for example between about 2° and about 60°, for example between about 10° and about 60°. Such an angularly sectorized diffraction grating is invariant by azimuthal rotation from one sector to another. The azimuthal invariance is discrete for an angular deviation equal to 360° divided by the number of angular sectors. If the number of angular sectors is high, the invariance effect that is obtained is substantially continuous. A two-dimensional diffraction grating refers to a diffraction grating comprising both concentric or pseudo-concentric grating lines and radial or pseudo-radial grating lines.

According to one or more embodiments, in the case of a two-dimensional diffraction grating, at least one parameter of the diffraction grating is different between the concentric or pseudo-concentric grating lines and the radial or pseudo-radial grating lines (depth and/or period and/or profile) in order to obtain a color difference between an up/down tilt and a right/left tilt.

In an optical security component according to the first aspect, the sub-wavelength diffraction grating that modulates each microstructure is configured to produce a colored effect after the second layer has been deposited. In general, a colored effect results from optical resonance that allows band-stop or band-pass filters to be generated.

According to one or more embodiments, the sub-wavelength diffraction grating is configured to produce guided-mode optical resonance as described in [Reference 1] or [Reference 2].

In these embodiments, the second layer is a thin layer of transparent dielectric material having a second refractive index and being encapsulated between said first layer of dielectric material and a third layer of dielectric material having a third refractive index. The second refractive index differs from the first refractive index, on the one hand, and from the third refractive index, on the other hand, by more than or equal to about 0.3, advantageously by more than or equal to about 0.5 as an absolute value.

According to one or more embodiments, said thin layer of dielectric material is a layer of material referred to as a high refractive index (HRI) material having a refractive index ranging, for example between 1.8 and 2.9, advantageously between 2.0 and 2.4, and the neighboring layers (first and third layers) are “low refractive index” layers having refractive indices ranging, for example between 1.3 and 1.8, advantageously between 1.4 and 1.7. For example, said second layer comprises a material selected from among: zinc sulfide (ZnS), titanium dioxide (TiO₂), silicon nitride (Si₃N₄).

A thin layer within the meaning of the present description is a layer with a thickness ranging between about 5 nm and about 250 nm, preferably between about 10 nm and about 150 nm. The thickness of the thin layer of transparent dielectric material ranges, for example between about 20 nm and about 200 nm and preferably between about 60 nm and about 150 nm.

The sub-wavelength diffraction grating configured to produce guided-mode optical resonance is, for example, a grating with a concentric or pseudo-concentric dimension, for example, and comprises one or more pitches between about 150 nm and about 400 nm, advantageously ranging between about 200 nm and about 400 nm. The sub-wavelength diffraction grating also can be a radial or pseudo-radial grating with a fixed pitch ranging between about 150 nm and about 400 nm, advantageously ranging between about 200 nm and about 400 nm. The sub-wavelength diffraction grating also can be a two-dimensional grating, with a concentric or pseudo-concentric dimension with a fixed or variable pitch and a radial or pseudo-radial dimension with a constant pitch. The depth of the grating ranges, for example, between about 30 nm and about 250 nm. The profile of the grating is, for example, sinusoidal or pseudo-sinusoidal or rectangular. During operation, such a diffraction grating is configured to excite guided modes within said thin layer of transparent dielectric material, forming a band-pass resonant filter in reflection, the resonance spectral band of which is centered on a wavelength determined in a known manner as a function of the features of the grating and of the nature of the layers.

This results in a colored effect that notably depends on the type of diffraction grating and on the one or more pitches of the diffraction grating, or on the refractive index of the layers.

In a first embodiment, with a periodic, concentric diffraction grating (one dimension) with a constant pitch, an observer can thus observe, in reflection, a stable colored effect in an up/down tilt with a first color and a color change when the component is tilted to the left or to the right to reveal a second color. Such an optical security component will preserve the colored effect during an azimuthal rotation by a given angle, for example an angle ranging between 30° and 150°, i.e., the same colors will be visible during up/down and/or left/right tilting.

In a second embodiment, with a periodic, concentric diffraction grating (one dimension) with a variable pitch, an observer will be able to observe, in reflection, a variable colored effect during an up/down tilt around a first color, due to the variation of the period, and will be able to observe, in reflection, a different variable colored effect during a left/right tilt. Such an optical security component will also preserve the colored effect during an azimuthal rotation. In a third embodiment, with a radial or pseudo-radial diffraction grating (one dimension) with a constant pitch, an observer will be able to observe, in reflection, a stable colored effect in a left/right tilt with a first color and a color change when the component is tilted upward or downward to reveal a second color. Such an optical security component will preserve the colored effect during an azimuthal rotation.

In a fourth embodiment, with a two-dimensional (radial or pseudo-radial and concentric) periodic diffraction grating with a constant pitch in each of the dimensions, and in which at least one parameter of the diffraction grating differs between the radial or pseudo-radial grating lines and the concentric grating lines, an observer will be able to observe, in reflection, a stable colored effect in a left/right tilt with a first color and a stable colored effect in a left/right tilt but with a second color different from the first color. Such an optical security component will preserve the colored effect during an azimuthal rotation.

According to one or more embodiments, the sub-wavelength diffraction grating is configured to produce a plasmon resonance effect in reflection, as described, for example, in [Reference 3] or [Reference 4].

In these examples, the second layer is metal and comprises a thin layer of metal material, for example silver, aluminum, gold, chromium, copper, advantageously with a thickness of more than about 40 nm. Advantageously, said metal layer is thick enough to have maximum residual transmission as a function of the wavelength of 2 %.

As in the preceding examples, the sub-wavelength diffraction grating can include one or more pitches ranging between about 150 nm and about 400 nm, advantageously ranging between about 200 nm and about 400 nm; the sub-wavelength diffraction grating is, for example, a grating with a dimension, for example a concentric or radial or pseudo-radial dimension, or a two-dimensional grating, with a concentric dimension and a radial or pseudo-radial dimension. The depth of the grating ranges, for example, between 30 nm and 200 nm. The profile of the grating is, for example, sinusoidal or pseudo-sinusoidal or rectangular. The diffraction grating can be periodic with a constant pitch in one direction, or can have a plurality of pitches or a variable pitch in the case of a concentric grating.

During operation, such a diffraction grating is configured to excite plasmon modes at the metal-dielectric interface, forming a reflection band-stop resonant filter, the resonance spectral band of which is centered on a wavelength determined in a known manner as a function of the features of the grating and of the natures of the layers.

This results in a colored effect that depends on the type of diffraction grating and on the one or more pitches of the diffraction grating and on the refractive indices of the layers.

The colored effects are then substantially identical to those described above, for diffraction gratings configured to excite guided modes within a thin layer of transparent dielectric material.

According to one or more embodiments, the sub-wavelength diffraction grating is configured to produce a plasmon resonance effect in transmission, as described in [Reference 6], for example.

In these examples, the second layer comprises a thin layer of metal material, for example of silver or aluminum, advantageously with a thickness ranging between 10 nm and 50 nm.

The sub-wavelength diffraction grating comprises one or more pitches ranging between about 150 nm and about 400 nm, advantageously ranging between about 200 nm and about 400 nm; the sub-wavelength diffraction grating is, for example, a one-dimensional grating, for example a concentric or radial or pseudo-radial grating, or a two-dimensional grating, with a concentric dimension and a radial or pseudo-radial dimension. The depth of the grating ranges, for example, between 50 nm and 200 nm. The profile of the grating is sinusoidal or pseudo-sinusoidal, for example. The diffraction grating can be periodic with a constant pitch in one direction, or can have a plurality of pitches or a variable pitch (which is the case for concentric gratings).

During operation, such a diffraction grating is configured to excite and couple surface plasmon modes on the two metal/dielectric interfaces on either side of the metal layer, thus allowing a resonant transmission effect to be provided. The resulting effect is a transmission band-stop resonant filter, the resonance spectral band of which is centered on a wavelength determined in a known manner as a function of the features of the grating and of the natures of the layers.

This results in a colored effect that depends on the type of diffraction grating and on the one or more pitches of the diffraction grating and on the refractive indices of the layers.

According to a first embodiment, with a periodic, concentric or pseudo-concentric diffraction grating (one dimension) with a constant pitch, an observer can thus observe, in transmission, a stable color, for example green along the up/down tilt axis and blue along the right/left tilt axis.

According to one or more embodiments, the optical security component according to the first aspect comprises at least a second structure etched into said first layer, with said second layer at least partially covering said second structure. The second structure is configured to form, for example, and in a non-limiting manner, another structure according to the present description, a scattering structure, a holographic structure, a diffractive structure, for example a structure for achieving an effect called Alphagram® as developed by the applicant.

According to one or more embodiments, the optical security component according to the first aspect comprises said at least first diffractive structure and at least a second diffractive structure, wherein said at least first diffractive structure and said at least second diffractive structure have contours configured to generate macroscopic patterns recognizable to the naked eye by an observer and consist of optical elements comprising identical microstructures modulated by different diffraction gratings.

It is thus possible to generate colored scenarios that are easily recognizable by an observer.

In some embodiments, the diffraction grating of said at least first diffractive structure is circular, pseudo-circular or pseudo-radial with a constant pitch and the diffraction grating of said at least second diffractive structure is linear with a constant pitch, with an identical pitch to that of the diffraction grating of said at least first diffractive structure.

In some embodiments, the diffraction grating of said at least first diffractive structure is circular or pseudo-circular with a constant pitch and the diffraction grating of said at least a second diffractive structure is pseudo-radial, with an identical pitch to that of the diffraction grating of said at least first diffractive structure. According to one or more embodiments, the optical security component according to the first aspect comprises one or more additional layers depending on the requirements of the application, these additional layers may or may not contribute to the desired visual effect. Thus, according to one or more embodiments, the optical security component is configured to secure an object, for example a document or a product, and further comprises, on the face opposite the observation face, a layer suitable for transferring the component onto the document or the product, for example an adhesive layer or a layer of reactivatable adhesive.

According to one or more embodiments, the optical security component further comprises, on the side of the first observation face, a support film intended to be detached after transferring the component onto the document or the product.

According to one or more embodiments, the optical security component is configured to manufacture a security strip for securing banknotes, and comprises, on the side of the first observation face and/or on the face opposite the first observation face, one or more protective layers.

According to a second aspect, the present description relates to a secure object, for example a secure valuable document, comprising a substrate and an optical security component according to the first aspect, deposited onto said substrate or onto one of the layers of said substrate in the case of a multilayer substrate.

Such a secure object is, for example, and in a non-limiting manner: a banknote, an identity or travel document, on a paper or polymer substrate.

According to a third aspect, the present description relates to methods for manufacturing optical security components according to the first aspect.

Thus, the present description relates to a method for manufacturing an optical security component for securing an object, for example a valuable document, for example an identity document or a banknote, the method comprising:
depositing a first layer of dielectric material, transparent in the visible spectrum, onto a support film;
forming at least a first diffractive structure on said first layer;
depositing a second layer at least partially covering said first diffractive structure, and having a reflection spectral band in the visible spectrum, and wherein:
said first diffractive structure consists of a set of optical elements adjacent to each other, each optical element having a maximum dimension of less than about 300 μm and comprising a microstructure modulated by a sub-wavelength diffraction grating with one or more pitches ranging between about 150 nm and about 500 nm, such that:
   said microstructure is configured to deflect an incident light beam and is substantially invariant by azimuthal rotation by an angle of less than 90° about a first axis substantially perpendicular to a plane of the component;
   said sub-wavelength diffraction grating is substantially invariant by azimuthal rotation by an angle of less than 90° about a second axis substantially coincident with said first axis and is configured to produce a colored effect after the second layer has been deposited. According to a fourth aspect, the present description relates to a method for authenticating a secure object according to the second aspect using the naked eye, the authentication method comprising:
   observing the optical security component of said secure object along an observation axis forming a given observation angle with the illumination axis;
   a left/right and/or down/left tilting movement allowing a given variable colored effect to be observed;
   an azimuthal rotation movement by a predetermined angle allowing the preservation of said variable colored effect to be observed.

The azimuthal rotation angle advantageously ranges between about 30° and about 150°, for example between about 60° and about 120°.

For authentication with the naked eye, said first diffractive structure can have a contour configured to generate a recognizable macroscopic pattern with a minimum dimension that is greater than about 500 μm, preferably greater than about 1 mm, preferably greater than about 2 mm, preferably greater than about 5 mm.

According to a fifth aspect, the present description relates to a method for authenticating a secure object according to the second aspect by means of an optical imaging device, said authentication method comprising:
forming an image of said optical security component, by means of the optical imaging device;
a left/right and/or down/left tilting movement allowing a given variable colored effect to be observed;
an azimuthal rotation movement by a predetermined angle allowing the preservation of said variable colored effect to be observed.

For authentication by means of an optical imaging device, said first diffractive structure, in some embodiments, can be configured to generate a non-figurative pattern, for example a QR code. Moreover, due to the possible magnification of the optical imaging device, the dimensions of the pattern thus generated can be smaller than the dimensions required for ocular perception.

### BRIEF DESCRIPTION OF THE FIGURES

Further features and advantages of the invention will become apparent upon reading the following description, which is illustrated using the following figures:

FIG. 1A schematically illustrates a partial cross-sectional view of an embodiment of a component according to the present description;

FIG. 1B schematically illustrates a partial cross-sectional view of another embodiment of a component according to the present description;

FIG. 2A schematically illustrates a partial three-dimensional view of microstructures in a component according to the present description, each microstructure being formed by a microlens, the microlenses each being modulated, in this example, by a concentric diffraction grating;

FIG. 2B schematically illustrates a partial three-dimensional view of microstructures in a component according to the present description, each microstructure being formed by a subset of facets;

FIG. 2C schematically illustrates a partial cross-sectional view of a subset of facets as illustrated in FIG. 2B, modulated by a sub-wavelength diffraction grating;

FIG. 3A illustrates a first example of a sub-wavelength diffraction grating in a component according to the present description, the diffraction grating being concentric and with a constant pitch;

FIG. 3B illustrates a second example of a sub-wavelength diffraction grating in a component according to the present description, the diffraction grating being concentric and with a variable pitch;

FIG. 3C illustrates a third example of a sub-wavelength diffraction grating in a component according to the present description, the diffraction grating being pseudo-radial;

FIG. 3D illustrates a fourth example of a sub-wavelength diffraction grating in a component according to the present description, the diffraction grating being two-dimensional, with a concentric component and a pseudo-radial component, the pitches in each of the dimensions being constant and different from each other;

FIG. 4A illustrates a colored visual effect of a first example of an optical security component according to the present description, observed by an observer in specular reflection and in 4 left/right, up/down tilt positions;

FIG. 4B illustrates a colored visual effect of the optical security component illustrated in FIG. 4A, observed by an observer in specular reflection and in 4 left/right, up/down tilt positions, after azimuthal rotation of the component by 90°;

FIG. 5 illustrates a colored visual effect of a second example of an optical security component according to the present description, observed by an observer in specular reflection and in 4 left/right, up/down tilt positions;

FIG. 6A illustrates a colored visual effect of a third example of an optical security component according to the present description, observed by an observer in specular reflection and in 4 left/right, up/down tilt positions;

FIG. 6B illustrates a colored visual effect of the optical security component illustrated in FIG. 6A, observed by an observer in specular reflection and in 4 left/right, up/down tilt positions, after azimuthal rotation of the component by 90°;

FIG. 7A illustrates a first example of an arrangement of optical elements in an optical security component according to the present description, the optical elements having a square contour;

FIG. 7B illustrates a second example of an arrangement of optical elements in an optical security component according to the present description, the optical elements having a hexagonal contour;

FIG. 7C illustrates a third example of an arrangement of optical elements in an optical security component according to the present description, the optical elements having a rectangular contour;

FIG. 8 illustrates an example of an arrangement of optical elements in an optical security component according to the present description, with different optical elements;

FIG. 9 illustrates another example of an arrangement of optical elements in an optical security component according to the present description, with different optical elements.

### DETAILED DESCRIPTION

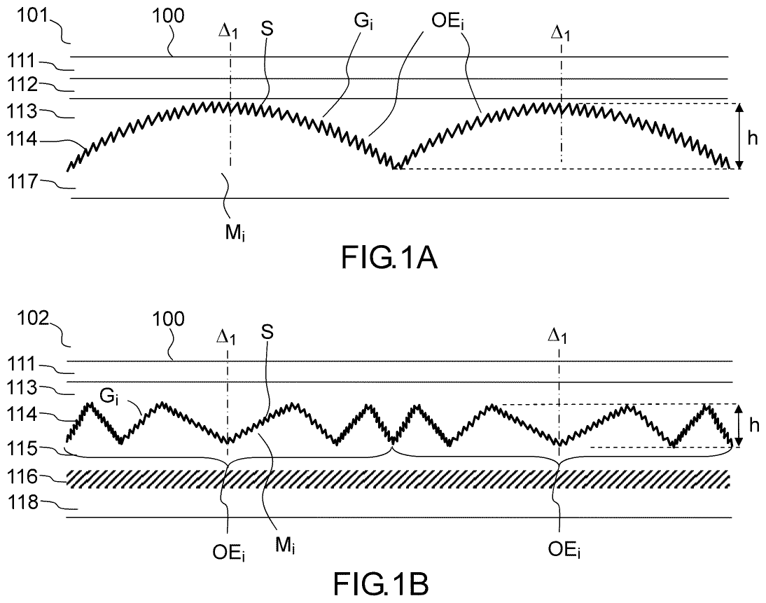

In the figures, the elements are not shown to scale for the sake of better visibility. FIG. 1A and FIG. 1B use partial cross-sectional views to schematically show two examples of optical security components according to the present description. The optical security component 101 shown in FIG. 1A represents, for example, an optical security component intended to be transferred in the form of a strip or a patch onto a document or a product with a view to securing it. It comprises, according to this example, a support film 111, for example a film of polymer material, for example a polyethylene terephthalate (PET) film that is a few tens of micrometers, typically 10 to 100 μm, thick, as well as a detachment layer 112, for example made of natural or synthetic wax. The detachment layer allows the polymer support film 111 to be removed after the optical component is transferred onto the product or document to be secured. The optical security component 101 further comprises a first layer 113 of dielectric material, having a first refractive index nᵢ and at least a first diffractive structure S consisting of optical elements OEᵢ and stamped on said first layer 113, and which will be described in more detail hereafter.

In the example of FIG. 1A, the optical security component 101 also comprises a second reflective layer 114, at least partially covering said first structure S, and having a reflection spectral band in the visible spectrum. The second layer 114 is, for example, a metal layer or a layer referred to as a refractive index variation layer having a refractive index n₂ that differs from the neighboring layers, with the difference in the refractive index from that of the neighboring layers assuming a value at least equal to 0.3, advantageously a value at least equal to 0.5.

As will be described in further detail hereafter, the first diffractive structure S consists of a set of optical elements, having a maximum dimension of less than about 300 μm. Each optical element comprises a microstructure Mᵢ configured to deflect the incident light, modulated by a sub-wavelength diffraction grating Gᵢ, i.e., a diffraction grating comprising one or more pitches ranging between about 150 nm and about 400 nm.

The microstructure Mᵢ is substantially invariant by azimuthal rotation by an angle of less than 90° about a first axis Δ₁ substantially perpendicular to a plane of the component. The microstructure has, for example, rotational symmetry. As illustrated in the example of FIG. 1A, the microstructure is a microlens, for example.

The sub-wavelength diffraction grating Gᵢ is substantially invariant by azimuthal rotation by an angle of less than 90° about a second axis substantially coincident with said first axis Δ₁.

The sub-wavelength diffraction grating Gᵢ is configured to produce a colored effect after the second layer 114 has been deposited. Examples of gratings will be described in further detail hereafter. The colored effect can result from guided-mode resonance, when the second layer 114 is made of dielectric material and has a refractive index difference at least equal to 0.3 with the neighboring layers, advantageously at least equal to about 0.5. In some embodiments, the layer 114 of dielectric material has a refractive index n₂ that is greater than the refractive indices n₁, n₃, of the neighboring layers and this is referred to as a high-index layer or HRI (High Refractive Index) layer. The colored effect can also result from plasmon resonance when the second layer 114 is metal.

The optical security component can also comprise one or more additional, optically functional or non-functional layers adapted to the application. For example, in the example of FIG. 1A, the optical security component further comprises a layer of adhesive 117, for example a layer of hot reactivatable adhesive, for transferring the optical security component onto the product or document.

In practice, as will be described hereafter, the optical security component can be manufactured by stacking the layers on the support film 111, then the component is transferred onto a document/product to be secured by virtue of the layer of adhesive 117.

Optionally, the support film 111 then can be detached, for example by means of the detachment layer 112. The main observation face 100 of the optical security component is thus located on the side of the first layer 113 opposite the structured face of the layer 113.

The optical security component 102 shown in FIG. 1B shows, for example, an optical security component intended for securing banknotes; this is, for example, a portion of a security thread intended to be integrated into the paper when the banknote is manufactured or a laminated strip covering a window in the paper. In this example, the component 102 comprises, as before, a support film 111 (12 to 50 μm) that will also act as a protective film for the security thread, and, as in the example of FIG. 1A, a first layer 113 of dielectric material having a first refractive index n₁, as well as at least a first diffractive structure S consisting of a set of optical elements OEᵢ. A second layer 114 at least partially covers said first diffractive structure S, and has a reflection spectral band in the visible spectrum. As described with reference to FIG. 1A, each optical element comprises a microstructure Mᵢ modulated by a sub-wavelength diffraction grating Gᵢ.

As illustrated in the example of FIG. 1B, and as will be described in further detail hereafter, each optical element OEᵢ can comprise a microstructure Mᵢ consisting of a subset of facets. The subset of facets comprises, for example, but in a non-limiting manner, one or more facets with rotational symmetry concentrically arranged around said first axis Δ₁. A subset of facets can have a similar light deflection optical effect to that of a microstructure as illustrated in FIG. 1A. A subset of facets is advantageous in that it includes a height h, defined by a distance between a lowest level of the facet and a highest level, and measured along an axis perpendicular to a plane parallel to the plane of the component, less than the height of a microstructure as illustrated in FIG. 1A.

The optical security component 102 further comprises, in the example of FIG. 1B, a set of optional layers 115, 116, 118. The layer 115 (optional) is, for example, a layer of dielectric material, for example a transparent layer or an opaque colored layer that allows the contrast to be enhanced; the layer 116 (optional) is, for example, a security layer, for example a discontinuous layer with a specific pattern locally printed with UV ink to produce a matching marking that can be checked by eye or in a machine; and the layer 118 (optional) is, for example, a protective layer, for example a second polymer film or a varnish. In the case of a laminated strip, the layer 118 can be an adhesive layer. As in the preceding example, manufacturing can involve stacking the layers on the support film 111. The dielectric layer 115 and the security layer 116 can form only one layer. The protective layer (or adhesive layer) 118 and the layer 115 can also form only one and the same layer.

It will be apparent to a person skilled in the art that other optically or non-optically functional layers can be added depending on the requirements of the application in each of the examples shown in FIGS. 1A and 1B and that the alternative embodiments shown in FIGS. 1A and 1B can be combined.

It should be noted that if the additional layers, for example the layer 117, or the layers 115, 116, 118, are transparent, as well as the destination support, the optical security component can be observed on both sides in order to be authenticated.

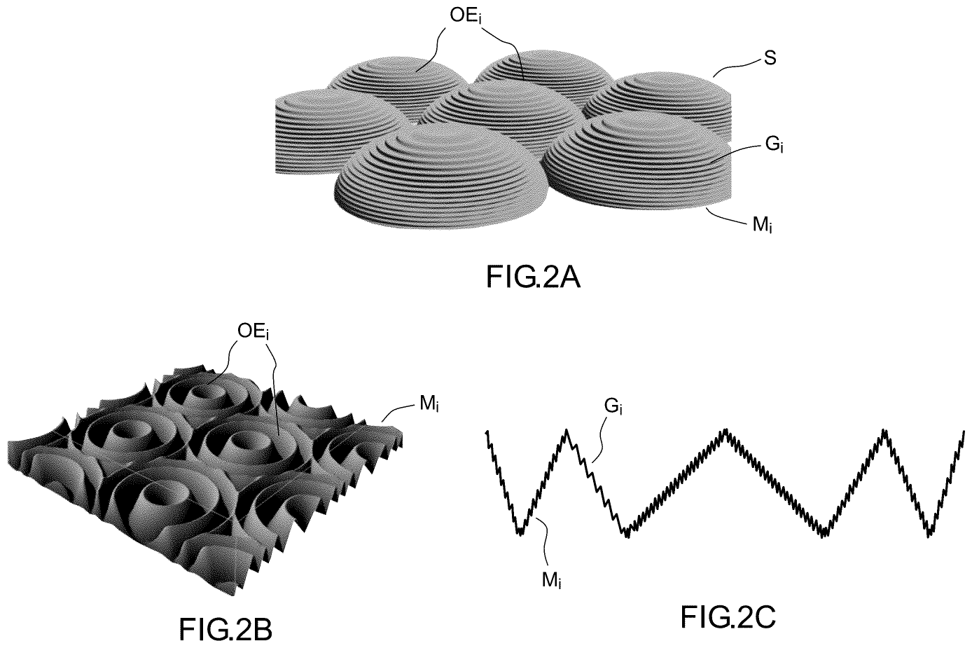

FIG. 2A schematically illustrates a partial three-dimensional view of an example of a diffractive structure S consisting of optical elements OEᵢ. In this example, each optical element OEᵢ comprises a microstructure Mᵢ formed by a microlens, modulated by a diffraction grating Gᵢ, in this example a constant pitch concentric diffraction grating.

In this example, the microlenses Mᵢ are, for example, microlenses with rotational symmetry, for example spherical or aspherical microlenses. However, other examples are possible.

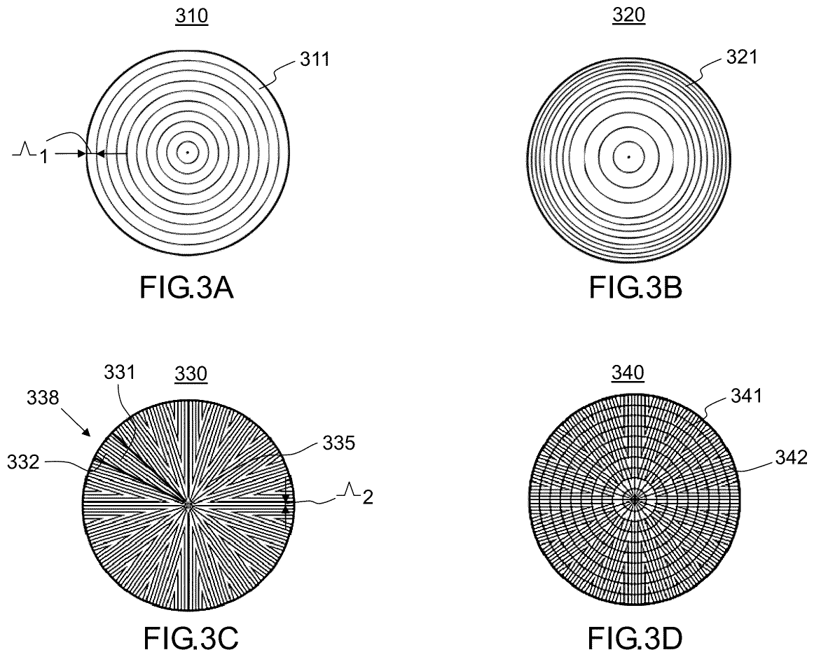

Furthermore, the microlenses Mᵢ can be modulated by a constant pitch pseudo-concentric diffraction grating, a variable pitch concentric or pseudo-concentric diffraction grating, a radial diffraction grating, an angularly sectorized diffraction grating, for example, a pseudo-radial diffraction grating, or a two-dimensional diffraction grating. Examples will be described with reference to FIGS. 3A to 3D.

FIG. 2B schematically illustrates a partial three-dimensional view of microstructures Mᵢ in a component according to the present description. In this example, each microstructure comprises a subset of facets.

FIG. 2C schematically illustrates, by way of an example, a partial cross-sectional view of a subset of facets as illustrated in FIG. 2B, modulated by a sub-wavelength diffraction grating.

Here again, the set of facets illustrated in FIG. 2B can be modulated by a constant pitch pseudo-concentric diffraction grating, a variable pitch concentric or pseudo-concentric diffraction grating, a radial diffraction grating, an angularly sectorized diffraction grating, for example, a pseudo-radial diffraction grating, or a two-dimensional diffraction grating.

FIG. 3A illustrates a first example of a sub-wavelength diffraction grating 310 in a component according to the present description, with the diffraction grating being concentric and with a constant pitch Λ₁. Such a concentric grating comprises concentric lines 311. Such a diffraction grating allows a stable colored effect to be observed in an up/down tilt and a color change to be observed in a left/right tilt. The same colored effect will be observed with a pseudo-concentric grating.

FIG. 3B illustrates a second example of a sub-wavelength diffraction grating 320 in a component according to the present description, with the diffraction grating being concentric and with a variable pitch. Such a diffraction grating will allow a variable colored effect to be observed in an up/down tilt, but this variable colored effect will be preserved by azimuthal rotation.

Here again, the same colored effect will be observed with a variable pitch pseudo-concentric grating.

FIG. 3C illustrates a third example of a sub-wavelength diffraction grating 330 in a component according to the present description, the diffraction grating being pseudo-radial, with a pitch Λ₂. As illustrated in FIG. 3C, the pseudo-radial diffraction grating 330 comprises radial grating lines 331 that extend from the center of the grating 335 defined by the intersection of the plane of the component with said second axis and pseudo-radial grating lines 332, parallel to the grating lines extending radially from the center of the grating. A pseudo-radial grating allows angular sectors 338 to be defined, inside which the grating lines are parallel, which allows a substantially constant pitch Λ₂ to be provided. The angular sectors have a vertex angle ranging, for example, between 2° and 60°. Although not shown, other angularly sectorized diffraction gratings can be contemplated.

FIG. 3D illustrates a fourth example of a sub-wavelength diffraction grating 340 in a component according to the present description, with the diffraction grating being two-dimensional, with a concentric component and a pseudo-radial component, and the pitches in each of the dimensions being constant but different from each other. Such a diffraction grating comprises concentric lines 341 and radial and pseudo-radial lines 342. Such a diffraction grating will allow a stable colored effect to be observed in an up/down tilt and a different color to be observed during a left/right tilt. This variable colored effect will be preserved by azimuthal rotation. Here again, the same colored effect will be observed with a pseudo-concentric component of the grating instead of the concentric component.

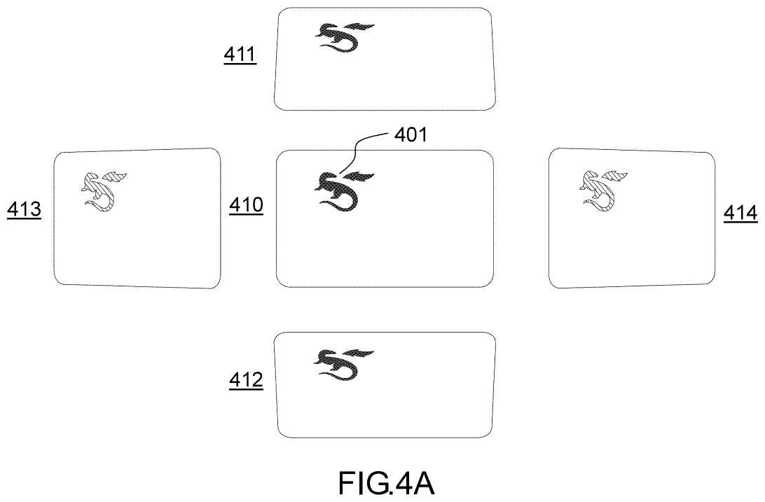

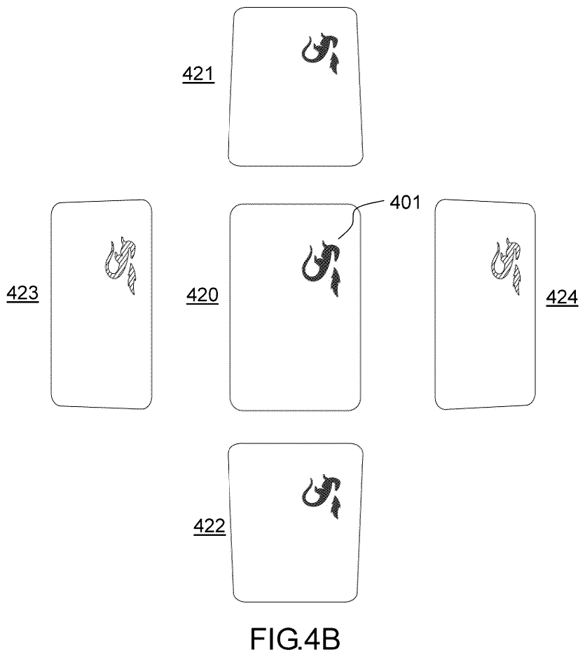

FIG. 4A illustrates a colored visual effect of a first example of an optical security component according to the present description, observed by an observer in specular reflection and in 4 left/right, up/down tilt positions.

In this example, the first diffractive structure of the optical security component has a contour configured to generate a macroscopic pattern 401, namely, a fire-breathing salamander, recognizable to the naked eye by an observer.

The first diffractive structure consists, for example, of a set of optical elements comprising microstructures each modulated by a two-dimensional sub-wavelength diffraction grating, with a first constant pitch in one dimension and a second constant pitch in the other dimension but different from the first pitch. The microstructures are microlenses, for example. The diffraction grating is concentric or pseudo-concentric in one dimension, with a pitch ranging between 280 nm and 320 nm and the diffraction grating is pseudo-radial in the other dimension, with a pitch ranging, for example between 230 nm and 270 nm. The second reflective layer is metal, for example configured to generate plasmon resonance.

The image 410 illustrates an observation around the direct reflection. The salamander can be seen with a first color, for example violet. The positions 411 and 412 correspond to an observation of the pattern 401 during an up/down tilt. Substantially the same first color, for example violet, is observed in positions 411, 412, with color stability during the up/down tilt that can range up to a few tens of degrees, for example at least ten degrees on either side of the central position.

The positions 413 and 414 correspond to an observation of the pattern during a left/right tilt. The salamander is then visible with a second color, for example blue. This can be explained because the positions 413/414 and 411/412 locally have a different 2D grating pitch and therefore a different color,

FIG. 4B illustrates a colored visual effect of the optical security component illustrated in FIG. 4A, observed by an observer in specular reflection and in 4 left/right, up/down tilt positions, after azimuthal rotation of the component by 90°.

Remarkably, it can be seen that after the azimuthal variation, the same colored effect is visible to an observer. Thus, the salamander appears with the first color (violet) in specular reflection (position 420) and in up/down tilt positions (positions 421, 422) and appears with a second color (blue) when the component tilts to the left or to the right (positions 423, 424).

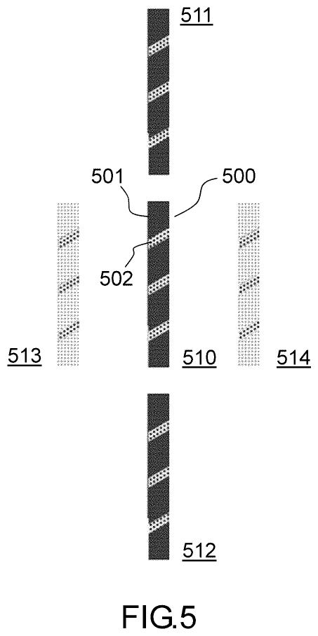

FIG. 5 illustrates a colored visual effect of a second example of an optical security component according to the present description, observed by an observer in specular reflection (510) and in 4 left/right (513/514), up/down (511/512) tilt positions.

In this example, the optical security component comprises first diffractive structures according to the present description and second diffractive structures.

The first diffractive structures of the optical security component form a macroscopic pattern 501 recognizable to the naked eye by an observer, namely, a vertical strip interrupted with oblique segments 502.

The first diffractive structures are formed, for example, by a set of optical elements, with each optical element comprising a microstructure modulated by a sub-wavelength, concentric or pseudo-concentric diffraction grating, with a first constant pitch, ranging, for example, between 260 nm and 320 nm. For example, the microstructures are subsets of facets, for example axicons with a number of facets ranging between 4 and 12.

The second diffractive structures of the optical security component generate said oblique segments 502.

The second diffractive structures comprise, for example, optical elements with microstructures similar to those of the first diffractive structures but each modulated by a linear sub-wavelength diffraction grating, with a second constant pitch, different from the first pitch. For example, the linear diffraction grating has a grating vector parallel to the main direction of the strips 501 and a pitch ranging between 330 nm and 370 nm.

In this example, the second reflective layer is, for example, a high-index layer configured for observing guided-mode resonances.

The position 510 corresponds to an observation of the pattern around the direct reflection.

The bottom 501 is visible in a first color, for example violet, while the oblique segments are visible in another color, due to the difference in pitch, for example red.

The positions 511 and 512 correspond to an observation of the pattern during an up/down tilt. Color stability is observed overall.

The positions 513 and 514 correspond to an observation of the pattern during a left/right tilt.

A variation in the color is observed only for the bottom 501: when the component is tilted from left to right, the bottom 501 changes color and becomes cyan, while the oblique segments 502 remain red.

If an azimuthal rotation of 90° of the component is carried out, the variable colored effect is preserved for the first diffractive structures (bottom 501), but the oblique segments turn green.

In one embodiment as illustrated in FIG. 5, it is also possible to make a message appear when in a determined position, the circular grating has the same period as the linear grating. This allows optical scenarios to be created exhibiting azimuthal metamerism.

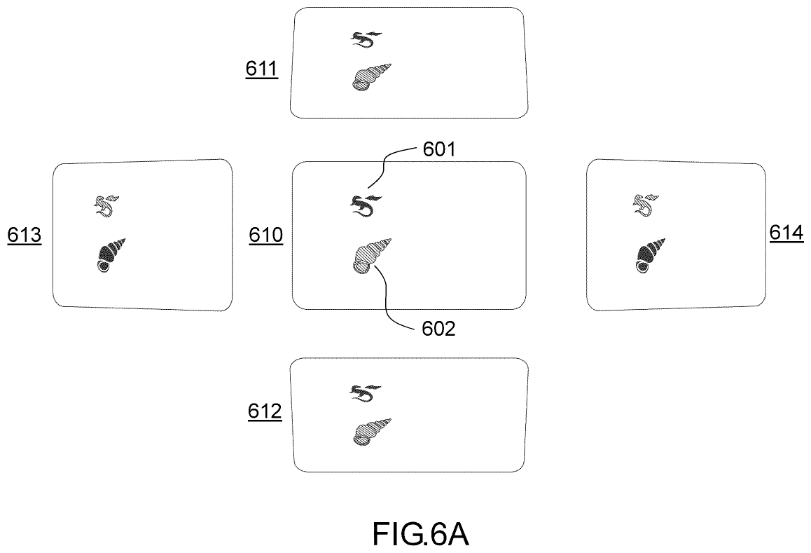

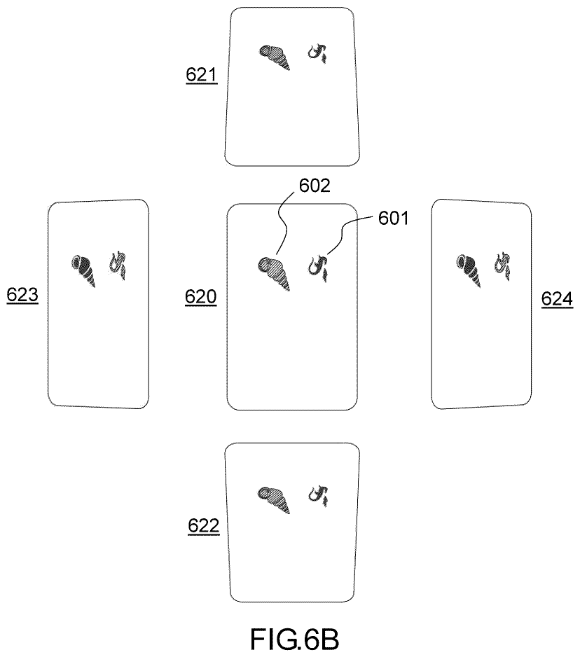

FIG. 6A illustrates a colored visual effect of a third example of an optical security component according to the present description, observed by an observer in reflection and in 4 left/right, up/down tilt positions.

In this example, a first diffractive structure of the optical security component has a contour configured to generate a macroscopic pattern 601 recognizable to the naked eye by an observer, namely, a fire-breathing salamander, as in the example of FIG. 4A, FIG. 4B. A second diffractive structure of the optical security component has a contour configured to generate a macroscopic pattern 602 recognizable to the naked eye by an observer, namely, a shell.

The first diffractive structure consists of a set of optical elements comprising, for example, microlenses modulated by a pseudo-radial diffraction grating, with a first constant pitch, for example a pitch ranging between about 330 nm and about 370 nm.

The second diffractive structure consists of a set of optical elements comprising, for example, microlenses identical to those of the first diffractive structure, modulated by a concentric sub-wavelength diffraction grating, with a second constant pitch substantially identical to the first pitch.

In this example, the second reflective layer is, for example, a high-index layer configured for observing guided-mode resonances.

The image 610 illustrates an observation around the direct reflection. The salamander can be seen with a first color, for example green, while the shell can be seen with a second color, for example red.

The positions 611 and 612 correspond to an observation of the pattern 601 during an up/down tilt. Substantially the same first color is observed, for example green for the salamander and red for the shell, in positions 611, 612, with color stability during the up/down tilt that can range up to a few tens of degrees. The positions 613 and 614 correspond to an observation of the pattern during a left/right tilt. The salamander then can be seen with the second color, for example red, while the shell can be seen with the first color, for example green.

FIG. 6B illustrates a colored visual effect of the optical security component illustrated in FIG. 6A, observed by an observer in reflection and in 4 left/right, up/down tilt positions, after azimuthal rotation of the component by 90°.

Remarkably, it can be seen that after the azimuthal variation, the same colored effect can be seen by an observer. Thus, the salamander appears with the first color (green) in specular reflection (position 620) and in up/down tilt positions (positions 621, 622) and appears with a second color (red) when the component is tilted to the left or to the right (positions 623, 624). The shell appears with the second color (red) in specular reflection (position 620) and in up/down tilt positions (positions 621, 622) and appears with the first color (green) when the component is tilted to the left or to the right (positions 623, 624).

In addition to the azimuthal stability of the colored effects of each of the optical elements, this configuration allows a color permutation to be obtained between the up/down and right/left tilt effect, i.e., the colors of the salamander and of the shell switch between the two tilt axes.

In the examples described above, the authentication also could be carried out by an imaging device.

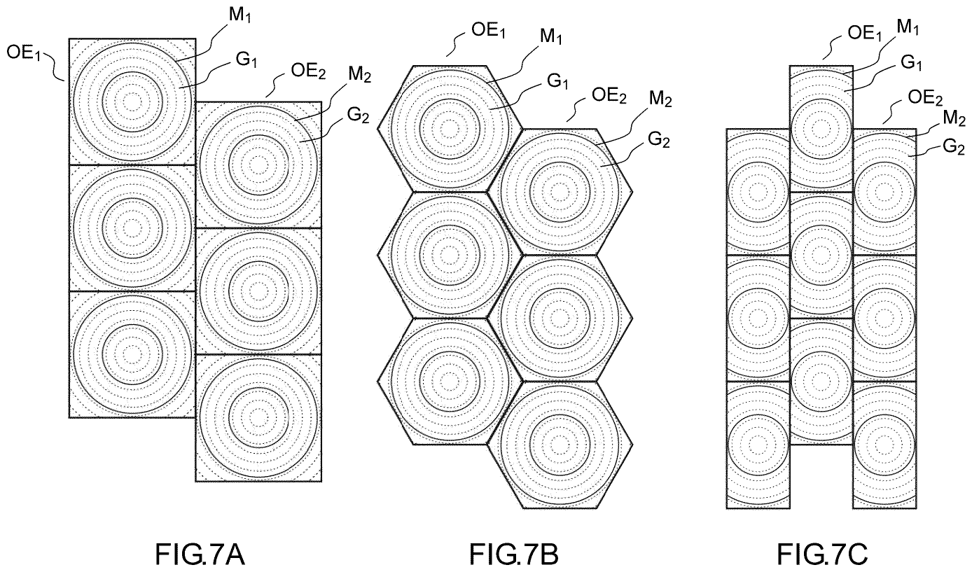

FIG. 7A illustrates a first example of an arrangement of optical elements OEᵢ in an optical security component according to the present description. In this example, the optical elements (OE₁, OE₂, etc.) are identical, and have a square contour in order to facilitate the arrangement. The optical elements each comprise a microstructure, respectively referenced M₁, M₂, modulated by a sub-wavelength diffraction grating, respectively referenced G₁, G₂. In this example, each microstructure comprises a set of facets (solid line), with only a few facets being shown in FIG. 7A. The set of facets is modulated by a concentric diffraction grating, with the concentric grating lines being represented by dashed lines, with only a few grating lines being shown.

FIG. 7B illustrates a second example of an arrangement of optical elements in an optical security component according to the present description. In this example, the optical elements comprise, as in the preceding example, a microstructure comprising a set of concentric facets modulated by a concentric diffraction grating. In this example, however, the optical elements have a hexagonal contour. It is thus possible to have a greater number of optical elements per unit area compared to a square mesh.

Of course, other contour shapes are possible for the optical elements.

Thus, FIG. 7C illustrates a third example of an arrangement of optical elements in an optical security component according to the present description, with the optical elements having a rectangular contour. Such an arrangement maximizes the observation dynamics or the intensity of the color, for example in an up/down tilt.

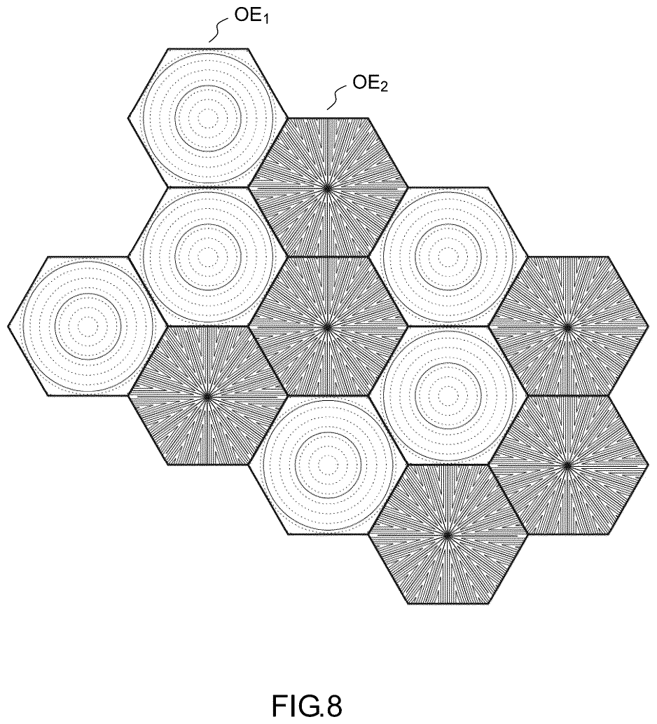

FIG. 8 illustrates an example of an arrangement of optical elements in an optical security component according to the present description, with different optical elements OE₁ and OE₂. The optical elements OE₁ are, for example, identical to those illustrated in FIG. 7B, while the optical elements OE₂ include a similar microstructure (not shown so as not to overload the drawing) but with a pseudo-radial diffraction grating. Such an arrangement allows composite colors to be created by mixing several optical elements.

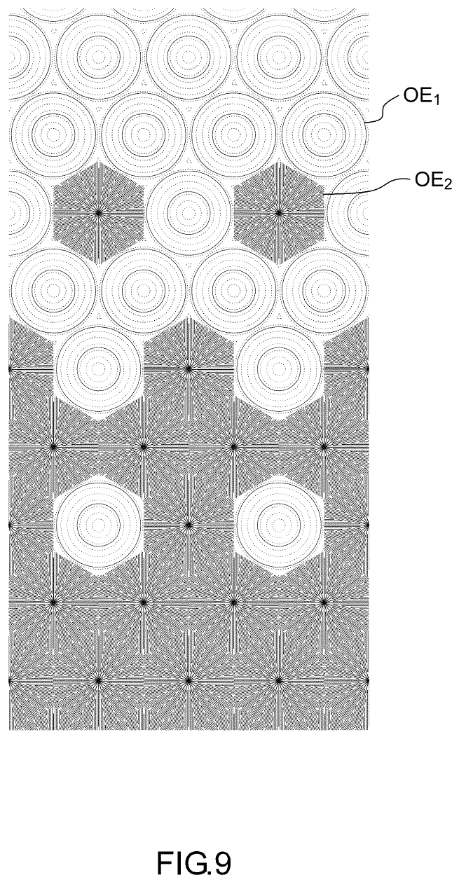

FIG. 9 illustrates another example of an arrangement of optical elements in an optical security component according to the present description, with optical elements OE₁ and OE₂ similar to the optical elements OE₁ and OE₂ illustrated in FIG. 8, but with a particular arrangement. In this example, a gradual change in the density of OE1 and OE₂ allows a component to be created that offers a gradual transition of colors.

Examples of a method for manufacturing optical security components according to the present description will now be described.

A first step comprises designing said at least first diffractive structure according to the procedures described above, as well as any other structures.

Next, a step of recording an original copy, also called optical master, is carried out. The optical master is, for example, an optical medium on which the one or more structures is/are formed.

The optical master can be formed using electron or optical lithography methods known in the prior art.

For example, according to a first embodiment, the optical master is produced by etching an electromagnetic radiation sensitive resin using an electron beam. In this embodiment, the structure with the first pattern modulated by the second pattern can be etched in a single step. According to another embodiment, an optical lithography technique (or photolithography) can be used. In this example, the optical master is a plate of photosensitive resin and the originating step is carried out by means of one or more exposures of the plate by projecting masks, of the phase mask type and/or of the amplitude mask type, followed by development in an appropriate chemical solution. For example, a first exposure is carried out by projecting amplitude masks whose transmission coefficients are adapted so that, after development, a relief corresponding to the microstructures is formed in the regions where the microstructures are provided. Next, a second exposure is carried out, for example, in accordance with optical lithography methods known to a person skilled in the art, for example two-photon lithography, in order to record the diffraction grating that modulates each microstructure.

Similar steps can be provided to generate other reliefs, such as, for example, a second diffraction grating in other regions. The order for forming the microstructures and the diffraction gratings is arbitrary and can be modified. Subsequently, the development step is carried out. In this way, an optical master comprising a first diffractive structure according to the present description is obtained after development.

The step of metal copying the optical master then can be carried out, for example, by galvanoplasty, as mentioned above, in order to obtain the metal replication matrix or “master”. According to one variant, a step of matrix duplication of the metal master can be carried out in order to obtain a large production tool suitable for replicating the structure on an industrial scale.

The manufacture of the optical security component then comprises a replication step. For example, the replication can be carried out by stamping (by hot embossing the dielectric material) the first layer 113 (FIGS. 1A, 1B) of dielectric material with a refractive index n₁, for example, a low-index layer, typically a stamping varnish that is a few microns thick. The layer 113 is advantageously supported by the support film 111, for example a 12 μm to 100 μm film made of polymer material, for example PET (polyethylene terephthalate). The replication also can be carried out by molding the layer of stamping varnish before drying and then UV casting. Replication by UV casting notably allows structures to be reproduced with a significant depth amplitude and allows better fidelity to be provided in the replication. In general, any other high-resolution replication method known from the prior art can be used in the replication step.

Then, all the other layers are deposited onto the accordingly embossed layer, for example the reflective layer 114, the layer of dielectric material 115 (optional), the security layer 116 (optional), which can be deposited evenly or selectively in order to reveal a new pattern and the layer of glue or varnish (117, 118) using a coating method.

Optional steps known to a person skilled in the art are possible, such as partial demetallization of the reflective layer 114. It is also possible to introduce a continuous or discontinuous opaque layer in order to enhance the contrast.

Although it has been described through a certain number of embodiments, the optical security component according to the invention and the method for manufacturing said component include different variants, modifications and improvements that will appear obvious to a person skilled in the art, with it being understood that these different variants, modifications and improvements form part of the scope of the invention as defined by the following claims.

### REFERENCES

Reference 1: EP 2264491
Reference 2: M. T. Gale, “Zero-Order Grating Microstructures” in R. L. van Renesse, Optical
Document Security, 2nd Ed., pp. 267-287
Reference 3: WO 2013/060817
Reference 4: WO 2020/229415
Reference 5: US 2010/0307705
Reference 6: WO 2012/136777
Reference 7: WO 2015/154943

1. An optical security component for securing an object, for example a valuable document, for example an identity document or a banknote, the component comprising:
a first layer of dielectric material, transparent in the visible spectrum, having a first refractive index;
at least a first diffractive structure etched into said first layer; and
a second layer, at least partially covering said first diffractive structure, and having a reflection spectral band in the visible spectrum; and wherein:
said first diffractive structure consists of a set of optical elements adjacent to each other, each optical element having a maximum dimension of less than about 300 μm and comprising a microstructure modulated by a sub-wavelength diffraction grating with one or more pitches ranging between about 150 nm and about 400 nm, such that:
said microstructure is configured to deflect an incident light beam and is substantially invariant by azimuthal rotation by an angle of less than 90° about a first axis substantially perpendicular to a plane of the component;
said sub-wavelength diffraction grating is substantially invariant by azimuthal rotation by an angle of less than 90° about a second axis substantially coincident with said first axis and is configured to produce a colored effect after the second layer has been deposited.

2. The optical security component as claimed in claim 1, wherein said second layer is a layer of dielectric material having a second refractive index (n₂), encapsulated between said first layer of dielectric material and a third layer of dielectric material having a third refractive index, the second refractive index differing from the first refractive index, on the one hand, and from the third refractive index, on the other hand, by more than or equal to about 0.3, advantageously by more than or equal to about 0.5 as an absolute value.

3. The optical security component as claimed in claim 1, wherein the second layer comprises a metal material.

4. The optical security component as claimed in claim 1, wherein said diffraction grating is selected from among: a concentric or pseudo-concentric diffraction grating, an angularly sectorized diffraction grating, for example a radial or pseudo-radial diffraction grating, a two-dimensional diffraction grating with a concentric or pseudo-concentric dimension and a radial or pseudo-radial dimension.

5. The optical security component as claimed in claim 1, wherein said diffraction grating comprises a variable pitch.

6. The optical security component as claimed in claim 1, wherein each microstructure consists of a subset of facets.

7. The optical security component as claimed in claim 1, wherein each optical element has a contour with a given shape selected from among: a circular shape, a rectangular shape, a hexagonal shape.

8. The optical security component as claimed in claim 1, wherein the optical elements of said first diffractive structure are identical.

9. The optical security component as claimed in claim 1, wherein said first structure has a contour configured to generate a macroscopic pattern recognizable to the naked eye by an observer.

10. The optical security component as claimed in claim 1, further comprising at least a second structure etched into said first layer, said second structure being selected, for example, from among: a scattering structure, a holographic structure, an Alphagram® type diffracting structure.

11. The optical security component as claimed in claim 1, comprising said at least first diffractive structure and at least a second diffractive structure, wherein said at least first diffractive structure and said at least second diffractive structure have contours configured to generate macroscopic patterns recognizable to the naked eye by an observer and consist of optical elements comprising identical microstructures modulated by different diffraction gratings.

12. A secure object, for example a secure valuable document, comprising a substrate and an optical security component as claimed in claim 1, deposited onto said substrate.

13. A method for manufacturing an optical security component for securing an object, for example a valuable document, for example an identity document or a banknote, the method comprising:
depositing a first layer of dielectric material, transparent in the visible spectrum, onto a support film;
forming at least a first diffractive structure on said first layer;
depositing a second layer at least partially covering said first diffractive structure, and having a reflection spectral band in the visible spectrum, and wherein:
said first diffractive structure consists of a set of optical elements adjacent to each other, each optical element having a maximum dimension of less than about 300 μm and comprising a microstructure modulated by a sub-wavelength diffraction grating with one or more pitches ranging between about 150 nm and about 400 nm, such that:
said microstructure is configured to deflect an incident light beam and is substantially invariant by azimuthal rotation by an angle of less than 90°about a first axis substantially perpendicular to a plane of the component;
said sub-wavelength diffraction grating is substantially invariant by azimuthal rotation by an angle of less than 90° about a second axis substantially coincident with said first axis and is configured to produce a colored effect after the second layer has been deposited.
